(19) United States
(12) Patent Application Publication
(10) Pub. No.: US 2024/0206639 A1
(43) Pub. Date: Jun. 27, 2024

(54) CUSHION

(71) Applicant: Lear Corporation, Southfield, MI (US)

(72) Inventors: David HALE, Southfield, MI (US); Wu Pan ZAGORSKI, Clawson, MI (US); Samuel BLAIR, Troy, MI (US); Joshua HALLOCK, Warren, MI (US)

(21) Appl. No.: 18/087,852

(22) Filed: Dec. 23, 2022

(51) Int. Cl. A47C 27/12; A47C 7/26; A47C 27/00; B29D 99/00

(52) U.S. Cl. CPC A47C 27/12; A47C 7/26; A47C 27/002; B29D 99/0092; B29K 2105/26

(57) ABSTRACT

A cushion is provided with a unitary mesh of expanded thermoplastic resin strands. A weld is formed at least partially along the mesh.

### TECHNICAL FIELD

Various embodiments relate to cushions formed from a unitary mesh of expanded thermoplastic resin strands.

### BRIEF DESCRIPTION OF THE DRAWINGS

FIG. 1 is a front perspective view of a seat assembly according to an embodiment;

FIG. 2 is a partial perspective view of cushions of the seat assembly of FIG. 1, according to an embodiment;

FIG. 3 is perspective view of a manufacturing method according to an embodiment;

FIG. 4 is another perspective view of the manufacturing method of FIG. 3;

FIG. 5 is another perspective view of the manufacturing method of FIG. 3;

FIG. 6 is a perspective view of a manufacturing method according to another embodiment;

FIG. 7 is a perspective view of the manufacturing method of FIG. 6; and

FIG. 8 is a perspective view of the manufacturing method of FIG. 7.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including.” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

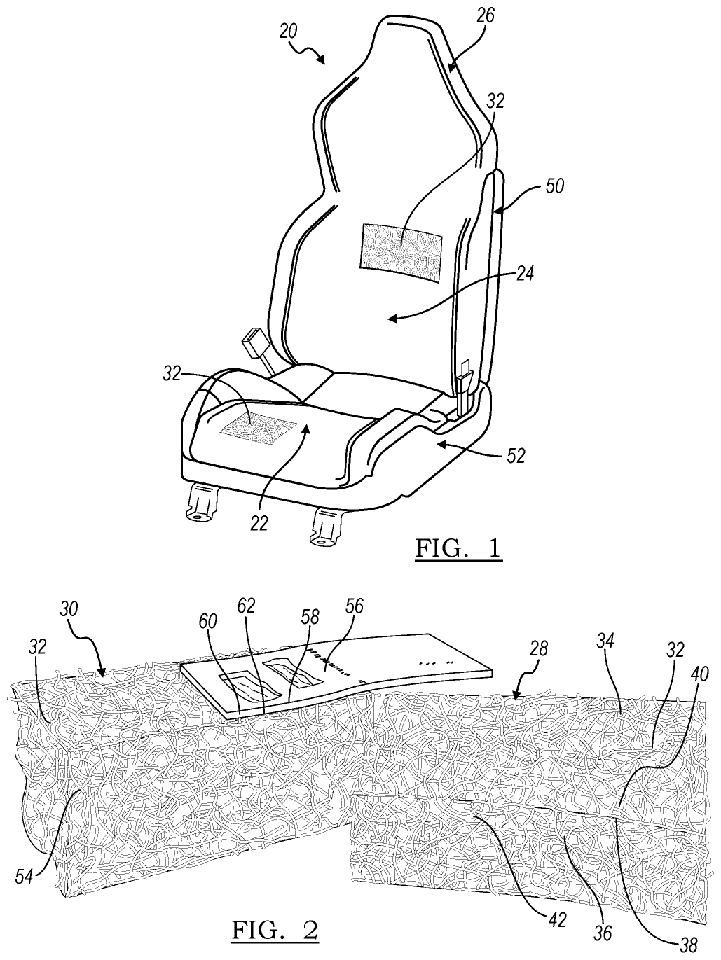

FIG. 1 illustrates a seat assembly 20 as a vehicle seat assembly 20 according to an embodiment. Although the vehicle seat assembly 20 is illustrated and described, any seat assembly 20 may be employed. The seat assembly 20 may be utilized in a land vehicle, aircraft, watercraft, or the like. The seat assembly 20 may also be utilized as an office chair, comfort chair, or the like.

The depicted seat assembly 20 includes a seat bottom cushion 22 to support a pelvis and thighs of a seated occupant. The seat assembly 20 also includes a seat back cushion 24 to support a back and shoulders of the seated occupant. A trim cover 26 is provided over the seat cushions 22, 24 to conceal the cushions 22, 24 and provide a uniform and smooth contact surface for the occupant.

Referring now to FIG. 2, two cushions 28, 30 are partially illustrated, disassembled from the seat assembly 20. Each cushion 28, 30 is formed from a plurality of strands 32 of an extruded, expanded thermoplastic resin as disclosed in Geisler et al., U.S. provisional patent application 63/357,163 filed on Jun. 30, 2022, by Lear Corporation, the disclosure of which is incorporated in its entirety by reference herein.

The cushion 28 is provided by two mesh portions 34, 36 each formed from a unitary, non-foam mesh of thermoplastic resin strands 32. The mesh portions 34, 36 are joined together, at least partially along mating surfaces 40, 42 between the mesh portions 34, 36. A weld 38 is formed at least partially along the mating surfaces 40, 42 of the mesh portions 34, 36. The two mesh portions 34, 36 may be separately formed mesh layers 34, 36, or may be integrally formed as two separate regions 34, 36, that are folded to overlap to be welded.

The mesh portions 34, 36 may each include a skin 40, 42 formed as the mating surfaces 40, 42 of the mesh portions 34, 36 to increase a contact area for the weld 38. The skins 40, 42 may be formed by a denser concentration of the strands 32 at the mating surfaces 40, 42 to form the skins 40, 42 from a denser surface of strands 32. The weld 38 extends along the mesh portions 34, 36 as a seam therebetween, thereby enclosing the mesh portions 34, 36 and/or adjoining the separate segments 34, 36.

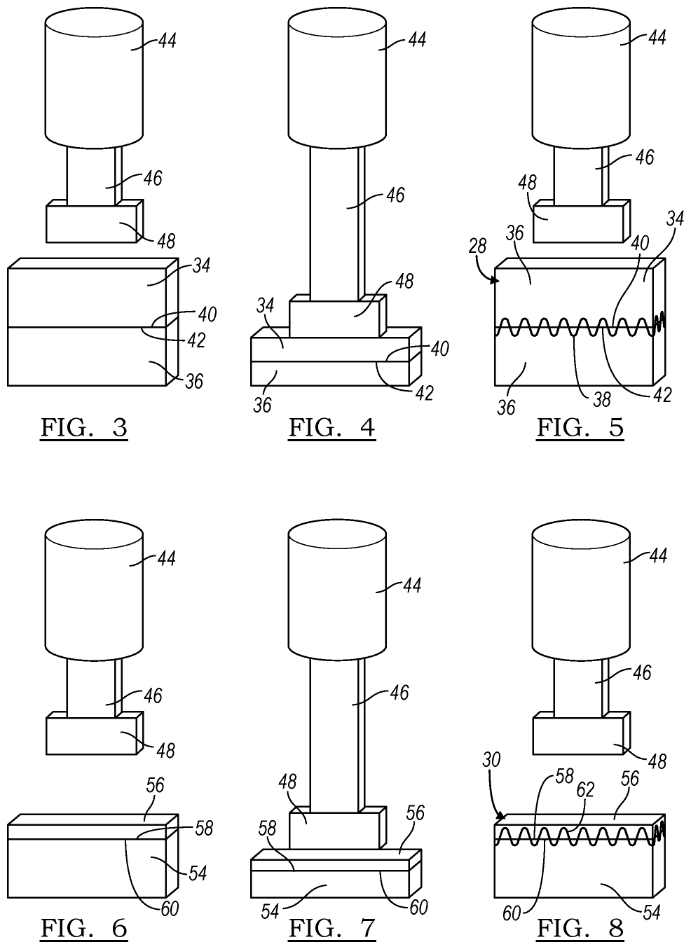

FIG. 3 illustrates the mesh portions 34, 36 stacked upon each other. The mesh portions 34, 36 are presented beneath a welder 44. The welder 44 may be automated or operated manually. According to one embodiment, the welder 44 is an ultrasonic welder 44. Any welder 44 may be employed, such as a heated welder or a friction stir welder. The welder 44 includes a welder arm 46 with a weld tip 48 at a distal end of the welder arm 46. In FIG. 4, the welder arm 46 extends the weld tip 48 into contact with the mesh portion 34 thereby compressing the mesh portions 34, 36 to enhance contact between the mesh portions 34, 36. In FIG. 4, the weld tip 48 is also vibrated ultrasonically under the pressure of the welder arm 46 to create friction between the mesh portions 34, 36 to melt the mesh portions 34, 36 at the mating surfaces 40, 42. The melted mating surfaces 40, 42 of the mesh portions 34, 36 cool to solidify and form the weld 38.

In FIG. 5, the weld arm 46 is retracted to permit the mesh portions 34, 36 to expand as the unitary welded cushion 28. The weld 38 includes a consistent depth, such as a quantity of strands 32 beyond the mating surfaces 40, 42. The quantity of strands 32 may be up to three strands 32, for example. The consistent depth of the weld 38 is more consistent and repeatable than an adhesive, which often drips beyond the mating surfaces, and creates a denser and inconsistent bond beyond the lower mating surface. By omitting adhesives, the cushion 28 is formed from one consistent material, thereby simplifying recyclability. Additionally, the weld 38 provides a flexibility that is less rigid in comparison to comparable adhesive bond.

The welded cushion 28 provides a lightweight, sustainable comfort solution for seat assemblies 20, thereby reducing vehicle weight, while maintaining occupant support, to reduce cost and enhance fuel efficiency. The strands 32 of the mesh portions 34, 36 provide a reduced surface area for bonding. However, compressing the mesh portions 34, 36 enhances the density and area of the mating surfaces 40, 42 to create the weld 38, which is stronger than adhesives in applicable testing, such as shear resistance. Although two mesh portions 34, 36 are illustrated welded together, any number of mesh portions 34, 36 and any number of welds 38 may be employed to fabricate various cushions 28.

Various parameters of the welding process can be varied for various specifications or applications. For example, the power, voltage, and current of the welder 44 can be adjusted to adjust the performance of the weld 38. Likewise, adjustment of proximity of a point of contact of the weld tip 48 and the mesh portion 34, and a pressure applied to the mesh portions 34, 36 by extension of the weld arm 46 can also vary the weld 38 performance. The time of the weld 38 can also be varied for varying the performance. At the welder tip 48, a frequency of the tip 48 can be varied for a varied weld performance. Additionally, a shape of the welder tip 48 can be adjusted to adjust performance to result in a surface weld, a point weld, or the like.

Various configurations of mating surfaces 40, 42 may also be employed to achieve different mating configurations. For example, both mating surfaces 40, 42 may include a skin layer. Alternatively, one of the mating surfaces 40 may include a skin layer, while the other mating surface 42 includes a less dense surface area of strands 32. In another embodiment, both mating surfaces 40, 42 do not include skin layers. Additionally, the weld 38 can be varied by varying the material of the mesh portions 34, 36, adjusting an area of the mating surfaces 40, 42, or changing a quantity of welds between the mesh portions 34, 36. Various materials may include polyethylene, linear low-density polyethylene, high density polyethylene, polypropylene, polycarbonate, thermoplastic polyester elastomer, acrylonitrile butadiene styrene, polyoxymethylene, or the like.

Referring again to FIG. 1, the cushion 28 is installed to a carrier 50 underneath the trim cover 26 with the seat assembly 20 according to an embodiment. In another embodiment, the cushion 28 is installed to a frame 52 and concealed by the trim cover 26. Regions of the trim cover 26 are partially removed in FIG. 1 to reveal the strands 32 of the cushion 28.

With reference now to FIG. 2, the cushion 30 is provided by a mesh portion 54, which is formed from a unitary, non-foam mesh of thermoplastic resin strands 32. A support 56 is attached to the mesh portion 54. The support 56 may be a trim component 56, such as a tab 56, as illustrated. The mesh portion 54 and the tab 56 are joined together, at least partially along mating surfaces 58, 60 between the mesh portion 54 and the tab 56. A weld 62 is formed at least partially along the mating surfaces 58, 60 of the mesh portion 54 and the tab 56. According to another embodiment, the support 56 is a suspension component. According to yet another embodiment, the support 56 is a carrier. The support 56 may be any weldable component utilized for attaching the mesh portion 54 to another seating component 56.

The mesh portion 54 may include a skin 60 formed as the mating surfaces 60 of the mesh portion 54 to increase a contact area for the weld 62. The skin 60 may be formed by a denser concentration of the strands 32 at the mating surfaces 60 to form the skin 60 from a denser surface of strands 32. The weld 62 extends along the mesh portion 54 and the tab 56 as a seam therebetween, thereby enclosing the mesh portion 54 and the tab 56 and/or adjoining the mesh portion 54 and the tab 56.

FIG. 6 illustrates the support 56 stacked upon the mesh portion 54. The mesh portion 54 and the tab 56 are presented beneath the welder 44. In FIG. 7, the welder arm 46 extends the weld tip 48 into contact with the support 56 thereby compressing the mesh portion 54 to enhance contact between the mesh portion 54 and the support 56. In FIG. 7, the weld tip 48 is also vibrated ultrasonically under the pressure of the welder arm 46 to create friction between the mesh portion 54 and the support 56 to melt the mesh portion 54 and the support 56 at the mating surfaces 58, 60. The melted mating surfaces 58, 60 of the mesh portion 54 and the tab 56 cool to solidify and form the weld 62.

In FIG. 8, the weld arm 46 is retracted to permit the mesh portion 54 to expand as the welded cushion 30. The weld 62 includes a consistent depth, such as a quantity of strands 32 beyond the mating surface 60. The quantity of strands 32 may be up to three strands 32, for example. The consistent depth of the weld 62 is more consistent and repeatable than an adhesive, which often drips beyond the mating surfaces, and creates a denser and inconsistent bond beyond the lower mating surface. By omitting adhesives, the cushion 30 is formed from one consistent material, thereby simplifying recyclability.

The welded cushion 30 provides a lightweight, sustainable comfort solution for seat assemblies 20, thereby reducing vehicle weight, while maintaining occupant support, to reduce cost and enhance fuel efficiency. The strands 32 of the mesh portion 54 provide a reduced surface area for bonding. However, compressing the mesh portion 54 enhances the density and area of the mating surfaces 60 to create the weld 62, which is stronger than adhesives in applicable testing, such as shear resistance. Although one mesh portion 54 and one support 56 are illustrated welded together, any number of mesh portions 54 and supports 56 and any number of welds 62 may be employed to fabricate various cushions 30.

Various parameters of the welding process can be varied for various specifications or applications. For example, the power, voltage, and current of the welder 44 can be adjusted to adjust the performance of the weld 62. Likewise, adjustment of proximity of a point of contact of the weld tip 48 and the mesh portion 54, and a pressure applied to the support 56 and the mesh portion 54 by extension of the weld arm 46 can also vary the weld 62 performance. The time of the weld 62 can also be varied for varying the performance. At the welder tip 48, a frequency of the tip 48 can be varied for a varied weld performance. Additionally, a shape of the welder tip 48 can be adjusted to adjust performance to result in a surface weld, a point weld, or the like.

Various configurations of mating surfaces 58, 60 may also be employed to achieve different mating configurations. For example, the mating surface 60 of the mesh portion 54 may include a skin layer. Additionally, the weld 62 can be varied by varying the material of the mesh portion 54 and the support 56, adjusting an area of the mating surfaces 58, 60, or changing a quantity of welds between the mesh portion 54 and the support 56. Various materials may include polyethylene, linear low-density polyethylene, high density polyethylene, polypropylene, polycarbonate, thermoplastic polyester elastomer, acrylonitrile butadiene styrene, polyoxymethylene, or the like.

Referring again to FIG. 1, the cushion 30 is installed to the trim carrier 50 underneath the trim cover 26 with the seat assembly 20 according to an embodiment. The cushion 30 can be welded directly to the carrier 50. Alternatively, the tab 56 can be attached to the carrier 50. In another embodiment, the cushion 30 is installed to the frame 52 by attachment of the tab 56, and the cushion 30 is concealed by the trim cover 26.

According to a first aspect, a cushion is provided with a unitary mesh of expanded thermoplastic resin strands. A weld is formed at least partially along the mesh.

According to a second aspect, the cushion of the first aspect is provided wherein the weld is formed at least partially along a surface of the mesh.

According to a third aspect, the cushion of the first aspect or the second aspect is provided wherein the mesh is further defined as a first mesh portion. A second unitary mesh portion of thermoplastic resins is provided and welded to the first mesh portion.

According to a fourth aspect, the cushion of the third aspect is provided wherein the first mesh portion further provided with a first mesh segment. The second mesh portion is provided with a second mesh segment.

According to a fifth aspect, the cushion of any of the first to fourth aspects is provided with a skin welded to the mesh.

According to a sixth aspect, the cushion of any of the first to fifth aspects is provided with a first skin bonded unitarily to the mesh. A second skin is welded to the first skin.

According to a seventh aspect, the cushion of any of the first to sixth aspects is provided wherein the weld extends along a region of the mesh as a seam.

According to an eighth aspect, the cushion of any of the first to seventh aspects is provided with a trim component welded to the mesh.

According to a ninth aspect, the cushion of the eight aspect is provided wherein the trim component is further provided with a tab to attach to another trim component.

According to a tenth aspect, the cushion of the eighth aspect or the ninth aspect is provided, wherein the mesh and the trim component are formed from a similar recyclable material.

According to an eleventh aspect, the cushion of any of the first aspect to the tenth aspect is provided with a support welded to the mesh.

According to a twelfth aspect, the cushion of the eleventh aspect is provided wherein the support is further provided with a trim carrier.

According to a thirteenth aspect, the cushion of any of the first aspect to twelfth aspect is provided wherein the weld is provided with a consistent quantity of strands.

According to a fourteenth aspect, the cushion of any of the first aspect to the thirteenth aspect is provided wherein the cushion is not provided with adhesives.

According to a fifteenth aspect, a seat cushion is provided with the cushion of any of the first aspect to the fourteenth aspect.

According to a sixteenth aspect, a seat assembly is provided with a seat frame. A cushion is provided according to any of the first aspect to the fifteenth aspect.

According to a seventeenth aspect, a method is provided by welding a first region of a mesh of expanded thermoplastic resin strands to a second region of a mesh of thermoplastic resin strands.

According to an eighteenth aspect, the method of the seventeenth aspect is further provided with stacking the first region of the mesh and the second region of the mesh prior to welding.

According to a nineteenth aspect, the method of the seventeenth aspect or the eighteenth aspect is further provided with stacking the first region from a first layer of the mesh and the second region from a second layer of the mesh prior to welding.

According to a twentieth aspect, the method of any of the seventeenth aspect to the nineteenth aspect is further provided with compressing the first region of the mesh and the second region of the mesh prior to welding.

According to a twenty-first aspect, the method of any of the seventeenth aspect to the twentieth aspect is further provided with extending a welder to contact the first region or the second region of the mesh to weld the first region and the second region of the mesh.

According to a twenty-second aspect, the method of the twenty-first aspect is further provided with retracting the welder after welding the first region and the second region of the mesh.

According to a twenty-third aspect, the method of any of the seventeenth aspect to the twenty-second aspect is further provided with ultrasonic welding the first region and the second region of the mesh.

According to a twenty-fourth aspect, the method of any of the seventeenth aspect to the twenty-third aspect is further provided with welding the first region of the mesh to the second region of the mesh of a unitary layer of the mesh.

According to a twenty-fifth aspect, the method of any of the seventeenth aspect to the twenty-fourth aspect is further provided with welding the first region of the mesh to the second region of the mesh without adhesives.

According to a twenty-sixth aspect, the method of any of the seventeenth aspect to the twenty-fifth aspect is further provided with varying power, voltage, current, welder extension distance, or weld frequency of a welder to vary a weld.

According to a twenty-seventh aspect, a cushion is formed by the method according to any of the seventeenth aspect to the twenty-sixth aspect.

According to a twenty-eighth aspect, a seat cushion if formed by the method according to any of the seventeenth aspect to the twenty-sixth aspect.

According to a twenty-ninth aspect, the method of any of the seventeenth aspect to the twenty-sixth aspect, is further provided with installing the welded regions of mesh into a seat assembly.

According to a thirtieth aspect, a method is provided by welding a first region of a mesh of expanded thermoplastic resin strands to a trim component or a support member.

According to a thirty-first aspect, the method of the thirtieth aspect is further provided by compressing the first region of the mesh prior to welding.

According to thirty-second aspect, the method of the thirtieth aspect or the thirty-first aspect is further provided by extending a welder to contact the first region of the mesh to weld the first region and the trim component or the support member.

According to a thirty-third aspect, the method of the thirty-second aspect is further provided with retracting the welder after welding the first region and the trim component or the support member.

According to a thirty-fourth aspect, the method of any of the thirtieth aspect to the thirty-third aspect is further provided with ultrasonic welding the first region and the trim component or the support member.

According to a thirty-fifth aspect, the method of any of the thirtieth aspect to the thirty-fourth aspect is further provided with welding the first region of the mesh to the trim component.

According to a thirty-sixth aspect, the method of any of the thirtieth aspect to the thirty-fifth aspect is further provided with welding the first region of the mesh to the support member.

According to a thirty-seventy aspect, the method of any of the thirtieth aspect to the thirty-sixth aspect is further provided with welding the first region of the mesh to the trim component or the support member without adhesives.

According to a thirty-eighth aspect, the method of any of the thirtieth aspect to the thirty-seventh aspect is further provided with varying power, voltage, current, welder extension distance, or weld frequency of a welder to vary a weld.

According to a thirty-ninth aspect, a cushion is formed by the method of any of the thirtieth aspect to the thirty-eighth aspect.

According to a fortieth aspect, a seat cushion is formed by the method of any of the thirtieth aspect to the thirty-eighth aspect.

According to a forty-first aspect, the method of any of the thirtieth aspect to the thirty-eighth aspect is further provided with installing the welded region of mesh and the trim component or the support member into a seat assembly.

While various embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

1. A cushion comprising a unitary mesh of expanded thermoplastic resin strands; and
a weld formed at least partially along the mesh.

2. The cushion of claim 1 wherein the weld is formed at least partially along a surface of the mesh.

3. The cushion of claim 1 wherein the mesh is further defined as a first mesh portion; and
wherein the cushion further comprises a second unitary mesh portion of thermoplastic resins welded to the first mesh portion.

4. The cushion of claim 3 wherein the first mesh portion further comprises a first mesh segment; and
wherein the second mesh portion further comprises a second mesh segment.

5. The cushion of claim 1 further comprising a skin welded to the mesh.

6. The cushion of claim 1 further comprising a first skin bonded unitarily to the mesh; and
a second skin welded to the first skin.

7. The cushion of claim 1 wherein the weld extends along a region of the mesh as a seam.

8. The cushion of claim 1 further comprising a trim component welded to the mesh.

9. The cushion of claim 8 wherein the trim component further comprises a tab to attach to another trim component.

10. The cushion of claim 8 wherein the mesh and the trim component are formed from a similar recyclable material.

11. The cushion of claim 1 further comprising a support welded to the mesh.

12. The cushion of claim 11 wherein the support further comprises a trim carrier.

13. The cushion of claim 1 wherein the weld comprises a consistent quantity of strands.

14. The cushion of claim 1 wherein the cushion does not comprise adhesives.

15. A seat cushion comprising the cushion of claim 1.

16. A seat assembly comprising:
a seat frame; and
a cushion according to claim 1.

17. A method comprising:
welding a first region of a mesh of expanded thermoplastic resin strands to a second region of a mesh of thermoplastic resin strands.

18. The method of claim 17 further comprising stacking the first region of the mesh and the second region of the mesh prior to welding.

19. The method of claim 17 further comprising stacking the first region from a first layer of the mesh and the second region from a second layer of the mesh prior to welding.

20-29. (canceled)

30. A method comprising:
welding a first region of a mesh of expanded thermoplastic resin strands to a trim component or a support member.

31-41. (canceled)
